(19) United States
(12) Patent Application Publication
(10) Pub. No.: US 2005/0283666 A1
(43) Pub. Date: Dec. 22, 2005

(54) Order management for replacing consumables

(75) Inventors: Paul R. Marshall, Redhill (GB); Ian A. Marsden, Redhill (GB)

Correspondence Address: PHILIPS INTELLECTUAL PROPERTY & STANDARDS, P.O. BOX 3001, BRIARCLIFF MANOR, NY, 10510, US

(73) Assignee: koninkijkle phillips n.v.

(21) Appl. No.: 10/528,621

(22) PCT Filed: Sep. 10, 2003
(86) PCT No.: PCT/IB03/03938

§ 371 Date: Mar. 22, 2005

(30) Foreign Application Priority Data
Sep. 25, 2002 (GB) 0222210.7

(51) Int. Cl. G06F 11/00

(52) U.S. Cl. 714/25

(57) ABSTRACT

A printer (21a) has a toner cartridge (30a) with a toner level detector (30b). A comparator (31) can detect when toner level is low, and a signaller (32) signals this to a PC (22) over a LAN. In the PC, signals from multiple printers (21a, 21b) are aggregated by an aggregator (34), which compiles a composite order. Automatic or manual filtering may be used before compiling the composite order. A signal constituting an order for replacement components is then sent by a messenger (39) over the internet (24) to a supplier website or e-mail address (26).

This invention relates to devices, to methods, and to systems for sending signals representing orders for replacement components. The invention relates also to a system for aggregating signals and for generating a composite order therefrom, and to a method including aggregating signals to form an aggregate component order.

Many devices now include means for indicating when the level of a consumable in a component thereof falls below a threshold. However, the re-ordering of components including consumables can be time consuming and have the potential for error. For example, the range of toner cartridges for laser printers and the like is so vast that it is quite easy for the wrong cartridge to be purchased. FR-A-2793443 discloses a machine which automatically orders replacement products, over the internet for example, when a low level is detected.

According to a first aspect of the invention, there is provided a device comprising:

a receiver for receiving a signal indicative of a level of a consumable in a component being below a threshold;

an output module responsive to the receiver for indicating that the component requires replacement;

an input module for receiving a signal indicative of an instruction to order the component; and

a messenger responsive to the input module for sending signals onto a communications network representing an order for a replacement component.

According to a second aspect of the invention, there is provided a system comprising:

a level detector for detecting if a level of a consumable in a component is below a threshold;

an output module responsive to the level detector for indicating that the component requires replacing;

an input module for receiving a signal indicative of an instruction to order the component; and

a messenger responsive to the input module for sending signals onto a communications network representing an order for a replacement component.

In the above, the output module might be a software module, which provides a signal to another software module running on the same processor, to a local hardware device or to remote software or hardware via a communications link, for example. The input module can take any suitable form, such as a key of a keyboard or keypad, a voice responsive input device, or a wireless module, such as a Bluetooth, infra-red or ultrasonic receiver, operated by a signal sent from a corresponding transmitter under control of a user or a system. The messenger might be an e-mail generating computer program, an automatic web-ordering program or a program which places an order by sending voice signals over a telephone system to a human operator at a remote location, for example.

According to a third aspect of the invention, there is provided a method comprising:

automatically determining if a level of a consumable in a component is below a threshold;

if a positive determination is made, indicating that the component requires replacing;

awaiting a signal indicative of an instruction to order the component; and

in response to receiving the instruction signal, sending via a communications network signals representing an order for a replacement component.

In these aspects, the indication may be an audible indication, such as a buzz, a beep or a synthesised or recorded voice indicator. Preferably, though, the indication is a visual one, made by way of a flashing or illuminated light or LED (light emitting diode) or made on a display such as an LCD (liquid crystal display) or a television screen, for example. In a preferred embodiment, the display forms part of a window displayed by a computer system on a monitor, for example.

The above aspects of the invention can allow component ordering to be dependent on user approval, which is especially significant when there are special circumstances of which only the user is aware. Also, this provides a user of knowledge of when components are ordered, and what components are ordered, allowing the user to feel that he or she is in control. Further control can be given by allowing a user to select a supplier of a replacement component, preventing the user feeling forced to order replacement components from a designated supplier. Current thinking applies great weight to the importance of not allowing a customer to believe that he or she is being forced into making a particular purchase. Free choice is thought to contribute to consumer happiness.

According to a fourth aspect of the invention, there is provided a device, comprising a receiver for receiving a signal in respect of each of plural components indicative of a level of a consumable in that component being below a threshold;

an aggregator for aggregating the received signals and for generating a composite order therefrom; and

a messenger responsive to the aggregator for sending signals onto a communications network representing an order for components in the composite order.

The messenger might be an e-mail generating computer program, an automatic web-ordering program or a program which places an order by sending voice signals over a telephone system to a human operator at a remote location, for example.

According to a fifth aspect of the invention, there is provided a system comprising:

a plurality of level detectors, each level detector being for detecting if a level of a consumable in a respective component is below a threshold and for sending a representative signal in response; and

an aggregator for aggregating signals from the level detectors and for generating a composite order therefrom.

According to a sixth aspect of the invention, there is provided a method comprising:

determining if a level of a consumable in each of two or more components in one or more devices is below a respective threshold;

sending an order signal to an aggregator; and

in the aggregator, aggregating signals in respect of each of the components to form an aggregate component order.

In the above, the aggregator could be a hardware or software queuing system, which buffers the received signals before allowing them to pass to be aggregated substantially simultaneously. Alternatively, the aggregator could be hardware or software arranged to aggregate the signals as they are received, with the composite order being changed when a received signal relates to a component deemed to be required to be included in the composite order.

Aggregation can have numerous advantages. In particular, ordering components in a group, rather than individually, is often easier to manage both in terms of the ordering and in terms of the handling of the components on arrival from a supplier. On the ordering side, aggregation can save time and money by avoiding the aggregation being carried out by a human operator. It also can reduce the possibility of incorrect ordering occurring due to human error. If an aggregate order is displayed or printed for modification prior to an order being sent, an operator can ensure that components are ordered efficiently, for example by sourcing like components from a single supplier, thereby saving delivery costs and/or allowing a bulk-ordering discount to be benefited from. Aggregation can easily result in ordered goods arriving together, which can make distribution easier and thus cheaper than otherwise might have occurred.

Embodiments of the present invention will now be described, by way of example only, with reference to the accompanying drawings, of which:

FIGS. 1, 2 and 3 are schematic diagrams of systems including devices according to and operating according to various aspects of the invention.

Referring to FIG. 1, a television 10 is provided with a wired two-way connection 11 to a set-top box 12. The connection 11 could instead be wireless. The television 10 is able to be controlled by a battery-powered remote control 13, which communicates with the television using infra-red signals. The set-top box 12 is connected to the internet 14 by a modem connection over a telephone line 15. The arrangement thus far described is conventional.

The remote control 13 includes a circuit 16 (not shown) which detects when the voltage across its internal battery or batteries 17 falls below a threshold, indicating that there is only a small amount of power remaining therein. On detecting a low battery level condition, the remote control 13 sends by infrared a signal indicating this fact to the television 10, which relays the signal to a receiver 18 in the set top box 12. In response, an output module 19a in the set top box 12 at an appropriate time (such as immediately following a program) controls the television 10 to display the text “remote control battery low—reorder?”

An input module 19b in the set top box 12 then awaits an input from a user, entered via the remote control 13. If the input is ‘no’, the set top box 12 removes the text message from the display on the television 10, and resumes normal operation. If the user input relayed from the remote control 13 by the television 10 to the set top box 13 is ‘yes’, a messenger M in the set top box 12 constructs a signal constituting an order for replacement batteries, and sends the signal to the website or e-mail address of a battery supplier over the internet 14. The transaction may be carried out in any convenient manner, for example using an account number already set-up with the supplier, or using an order signal which includes all the required transaction information, credit card details, delivery address, etc.

Alternatively, the set-top box 12 is arranged on receipt of a ‘battery-low’ signal from the television to display the text “Battery low, select an option: 1. Order from Philips 2. Order from supplier X 3. Do not order battery”. This allows the user to select which supplier to order batteries from. A signal representative of a user input is sent from the remote control 13 via the television to the set-top box 12, which sends an appropriate signal to the appropriate supplier's website or e-mail address via the internet 14. As well as the signal destination being different for different suppliers, the signals might also be different, for example the user may have an account with one supplier but not with another.

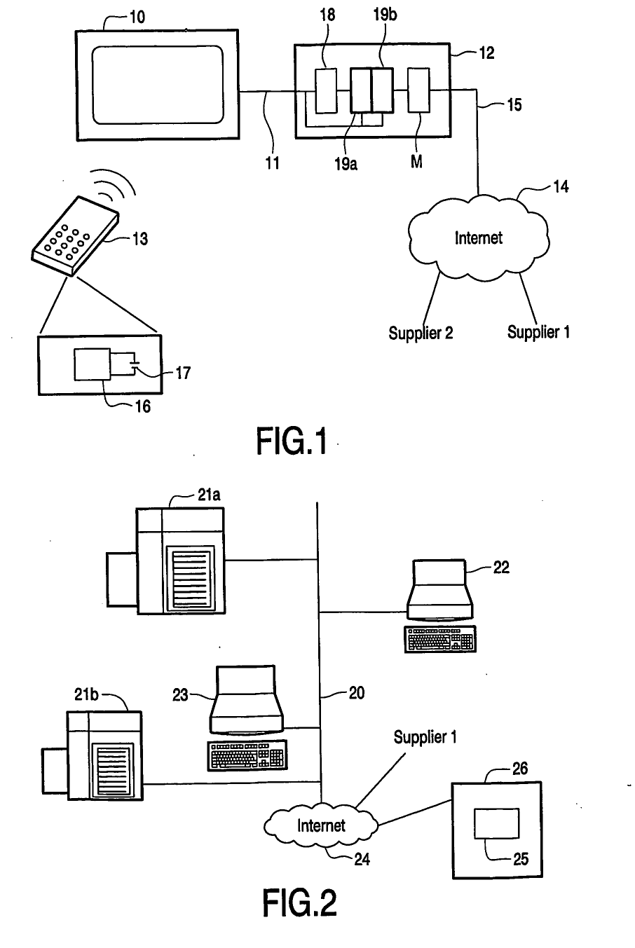

Another embodiment is shown in FIG. 2. Referring to FIG. 2, a computer network 20, such as a LAN (local area network), is shown having connected thereto a printer 21a, first and second PCs (personal computers) 22, 23 and the internet 24. The printer 21 includes a toner cartridge (not shown) having a toner level which decreases as toner is used by the printer. The printer 21 and/or the toner cartridge includes means to detect when the level of toner remaining in the cartridge falls below a threshold level. On detecting such a condition, the printer signals this via the LAN 20 to the first PC 22. All other devices (one of which is shown at 21b) which are connected to the LAN 20 and which include components having consumables are arranged similarly to the printer 21, i.e. each includes means for comparing the level of the consumable to a threshold and for sending a ‘consumable level low’ signal to the PC 22 when the level falls below the threshold. Each such device is arranged such that the generated signal includes an identification of the device and an identification of the component whose consumable is at a low level. Preferably at least some of the devices include multiple thresholds, so that multiple ‘level low’ signals are generated for a component, as the consumable level decreases with use. Such devices are arranged so that the signal sent to the PC 22 indicates also which threshold the signal relates to.

The PC 22 includes aggregate application software, to which all ‘level low’ signals are provided. The aggregator application aggregates the signals received over time to compile a composite order. The composite order may relate to all signals received over a fixed period of time, e.g. a week, or may be compiled only when the number of ‘level low’ signals exceeds a threshold. Alternatively, the monetary value of the replacement components corresponding to the ‘level low’ signals is calculated, and a composite order generated only when the sum of the value of the components exceeds a threshold. Since the components requiring replacement may need to be ordered from two or more suppliers, the aggregate application is arranged to prepare plural composite orders, one for each supplier. Each composite order may be prepared on any of the bases mentioned above. Different criteria may be used for each of the suppliers.

In respect of components which have multiple thresholds, the aggregator application can perform certain advanced functions. For example, if the aggregator application determines from the level of a consumable in a component that a replacement is required urgently, then a composite order including an order for that component is prepared even though the usual (quantity) conditions for preparing that composite order may not have been met. This arrangement decreases the possibility of the consumable running-down to a zero level before arrival of a replacement component. The aggregator application may detect the intervals between the receipt of signals relating to different thresholds of the same component, and infer from that the rate of consumption of the consumable and thus an expected time when the level will arrive at zero. Alternatively or in addition, a priority level is associated with each order signal, with a higher priority being given to a lower threshold level.

Obviously, where multiple order signals are received by the aggregator application in respect of a single component, the aggregator application is arranged to place only one order for that component.

Once a composite order has been prepared by the aggregator application, a signal representing an order for each of the components in that composite order is sent over the network to the website or e-mail address of the appropriate supplier. The signal includes an identification of each of the components required, and either account details or payment and delivery address information.

Alternatively, the aggregator application software is included at a supplier location, as is indicated at 25 at supplier site 26. In this embodiment, ‘level low’ signals from the devices are fed via the LAN 20 and the internet 24 to the aggregator application 25. Here, the order signals are aggregated to form a composite order on any suitable basis, such as one of the bases described above. Once a composite order has been prepared, the relevant components are collected together and sent for the purpose of maintaining the devices which sent the ‘level low’ signals.

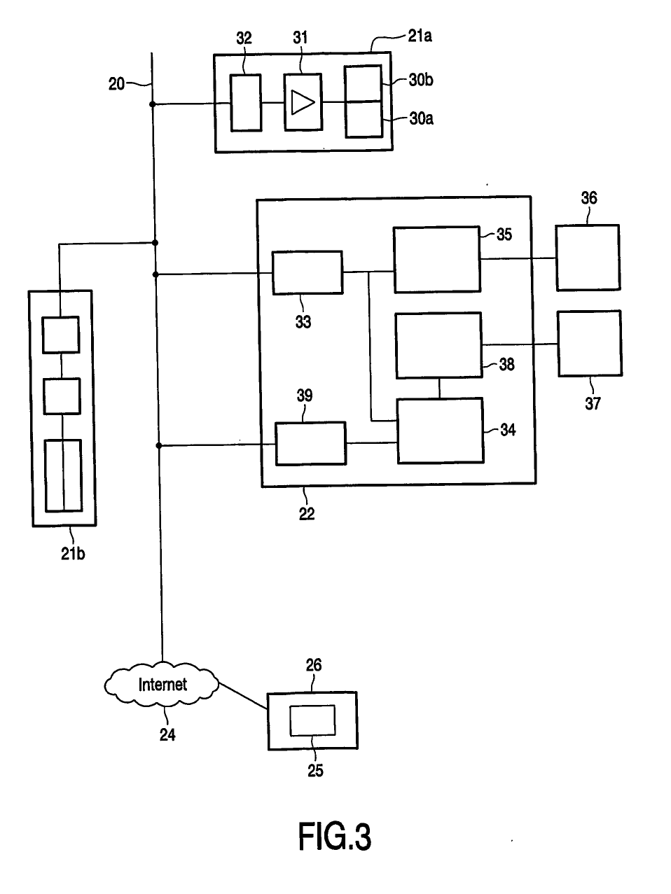

One implementation of the FIG. 2 system is shown in FIG. 3. Referring to FIG. 3, the printer 21a is shown including a toner cartridge 30a having a level detector 30b. A comparator 31 compares level signals provided by the level detector 30b to a threshold, and a signaller 32 places a signal on the LAN 20 when it is detected that the toner level is low. In the PC 22, a receiver 33 receives ‘low level’ signals from the LAN 20. An aggregator application 34 then aggregates the signals, and an output module 35 displays the aggregate orders on a monitor 36. Components can be selected by a user using a keyboard 37, an input module 38 detecting the selected components, following the aggregator prepares a composite order, which is then sent by a messenger 39 onto the internet 24 via the LAN 20.

Alternatively, the aggregator 34 aggregates the received ‘low level’ signals only after they have been manually filtered by a user using the monitor 36 and the keyboard 37. In either embodiment, manual filtering is only an option; automatic filtering is preferred.

If aggregation is to be carried out in the supplier site 26, the aggregator 34 may be omitted from the PC 22. In this embodiment, manual or automatic filtering may be performed using the PC 22.

From reading the present disclosure, other variations and modifications will be apparent to persons skilled in the art. Such variations and modifications may involve equivalent and other features which are already and which may be used instead of or in addition to features already described herein. Although Claims have been formulated in this Application to particular combinations of features, it should be understood that the scope of the disclosure of the present invention also includes any novel features or any novel combination of features disclosed herein either explicitly or implicitly or any generalisation thereof, whether or not it relates to the same invention as presently claimed in any Claim and whether or not it mitigates any or all of the same technical problems as does the present invention. The Applicants hereby give notice that new Claims may be formulated to such features and/or combinations of such features during the prosecution of the present Application or of any further Application derived therefrom.

1. A device (22) comprising:
a receiver (33) for receiving a signal indicative of a level of a consumable in a component (30a) being below a threshold;
an output module (35) responsive to the receiver for indicating that the component requires replacement;
an input module (38) for receiving a signal indicative of an instruction to order the component; and
a messenger (39) responsive to the input module for sending signals onto a communications network representing an order for a replacement component.

2. A device according to claim 1, including an aggregator (34) for aggregating level signals over a period of time, the messenger (39) being for sending signals representing an order for each replacement component for which an order instruction signal was received by the input module.

3. A system comprising:
a level detector (30b) for detecting if a level of a consumable in a component (30a) is below a threshold;
an output module (35) responsive to the level detector for indicating that the component requires replacing;
an input module (38) for receiving a signal indicative of an instruction to order the component; and
a messenger (39) responsive to the input module for sending signals onto a communications network (24) representing an order for a replacement component.

4. A system as claimed in claim 3, including an aggregator (34) for aggregating signals from plural level detectors, each associated with a respective component, the messenger (39) being for sending signals representing an order for each replacement component for which an order instruction signal was received by the input module.

5. A method comprising:
automatically determining if a level of a consumable in a component (30a) is below a threshold;
if a positive determination is made, indicating that the component requires replacing;
awaiting a signal indicative of an instruction to order the component; and
in response to receiving the instruction signal, sending via a communications network (24) signals representing an order for a replacement component.

6. A device (22), comprising
a receiver (33) for receiving a signal in respect of each of plural components (30a) indicative of a level of a consumable in that component being below a threshold;
an aggregator (34) for aggregating the received signals and for generating a composite order therefrom; and
a messenger (39) responsive to the aggregator for sending signals onto a communications network representing an order for components in the composite order.

7. A system comprising:
a plurality of level detectors (30b), each level detector being for detecting if a level of a consumable in a respective component (30a) is below a threshold and for sending a representative signal in response; and
an aggregator (34; 25) for aggregating signals from the level detectors and for generating a composite order therefrom.

8. A system as claimed in claim 7, comprising:
a messenger (39) responsive to the aggregator for sending signals onto a communication network representing an order for components in the composite order.

9. A method comprising:
determining if a level of a consumable in each of two or more components (30a) in one or more devices is below a respective threshold;
sending an order signal to an aggregator (34; 25); and
in the aggregator, aggregating signals in respect of each of the components to form an aggregate component order.

10. A method as claimed in claim 9, comprising sending signals onto a communications network (24) representing an order for the components included in the aggregate component order.
